(19) United States
(12) Patent Application Publication
(10) Pub. No.: US 2004/0241350 A1
(43) Pub. Date: Dec. 2, 2004

(54) Recording paper, recording method using the recording paper, and method for manufacturing the recording paper

(75) Inventors: Chizuru Koga, Ebina-shi (JP); Kiyoshi Hosoi, Ebina-shi (JP); Takashi Ogino, Ebina-shi (JP); Tsukasa Matsuda, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 10/856,988

(22) Filed: Jun. 1, 2004

(30) Foreign Application Priority Data
Jun. 2, 2003 (JP) 2003-156818

(51) Int. Cl. B41M 5/00

(52) U.S. Cl. 428/32.21

(57) ABSTRACT

The present invention provides a recording paper containing a substrate, and a method for manufacturing the recording paper. The substrate is manufactured by a method including cross-linking pulp fibers having reactive groups by covalent bonding via the reactive groups; and making paper following the cross-linking. The invention also provides an ink jet recording method for printing on the recording paper with ink, and an electrophotographic recording method for forming images on the recording paper by using an electrophotographic toner. The reactive groups preferably include a carboxyl group, and the amount of the carboxyl group contained in the pulp fibers before the cross-linking is in a range of about 5 to 15 meq per 100 g of the pulp fibers.

### BACKGROUND OF THE INVENTION

1. Field of the Invention

The present invention relates to a recording paper; a method for manufacturing the recording paper; and a method of recording according to an ink jet system or an electrophotographic system by using the recording paper.

2. Description of the Related Art

An ink jet recording system has been receiving widespread attention because of its features such as that it easily allows full color printing, it consumes less energy, it does not generate noise during recording, and printers therefor can be provided at a lower production cost. In recent years, the ink jet recording system achieved higher image quality, higher speed, and higher reliability, and at the same time, it has become more common to print on regular paper, which makes it essential to improve the suitability for recording on regular paper.

Recording media (recording papers) such as so-called regular paper, coated ink jet paper, glossy ink jet paper, white film, and transparent film are used in these ink jet recording systems. Especially when such systems are used in an office together with laser printers and copying machines, regular paper is mostly used, since it is economical and readily available, and since images can be easily formed thereon by these electrophotographic recording devices as well. Therefore, it is extremely important to improve the recording suitability of ink jet recording systems to regular paper. However, conventional ink jet recording systems have had the following disadvantages in printing on the regular paper.

It is the mainstream method to print images by ejecting an aqueous ink containing a great amount of water in the ink jet recording system. In such a system, printing is always accompanied by addition of a great amount of water onto the recording paper. Paper is a sheet-shaped material in which pulp fibers are bound to each other by hydrogen bonds, and penetration of water molecules into the hydrogen bond network expands an inter-fiber distance and causes dimensional change of the paper. Dimensional change over the entire paper is called “curl”, while unevenness in a local area thereof is called “cockle” or “cockling”. Curl and cockle immediately after printing often cause problems in conveying recording papers and in printing on both faces of the recording papers, in the ink jet printing system. In addition, as the printed ink dries, the water molecules that have penetrated into the regions of the hydrogen bond network evaporate, shortening the inter-fiber distances. During the drying process, new hydrogen bonds are formed at positions different from those before printing, causing a dimensional change different from that immediately after printing. Due to curl and cockle after printing and drying, the quality of documents printed by such ink jet system becomes lower than that of documents printed by dry printing systems such as electrophotographic systems and the like.

For the purpose of overcoming the problems of deformation of printed papers and of curl and cockle, there have be proposed methods of suppressing curl and cockle by relaxing the stress of a sheet by moistening the freshly processed sheet once again (see, for example, Japanese Patent Application Laid-Open (JP-A) No. 3-38375); suppressing curl and cockle by restricting the elongation in water of paper in the CD direction thereof (see, for example, JP-A No. 3-38376); suppressing curl and cockle by restricting the elongation in water of paper both in the MD and CD directions to 1.3 times or less (e.g., JP-A No. 3-199081); suppressing curl and cockle by restricting the elongation in water of paper in the operating direction of an ink ejecting portion to 2.0% or less (e.g., JP-A No. 7-276786); suppressing curl and cockle by restricting the elongation in water of paper in the CD direction to 1.8% or less (e.g., JP-A No. 10-46498); and suppressing cockle of a coated-type ink jet recording sheet by controlling the content of pigments in a substrate to within a range of about 5 to 35% by weight and maintaining the internal bonding strength of the recording sheet in a range of about 150 to 455 g/cm (e.g., Japanese Patent No. 3172298).

Japanese Patent Application Laid-open (JP-A) Nos. 3-38375, 3-38376, 3-199081, and 7-276786 disclose methods for suppressing curl and cockle. However, these methods make it impossible to use the recording papers as documents because curls increases when a large amount of ink is discharged by using an ink with high permeation into the recording paper or when a large amount of ink is discharged per unit of time as a result of a high printing speed, thereby requiring a reduction in the permeation of ink into the recording paper.

In the method disclosed in JP-A No. 10-46498, it has been attempted to reduce undulations after printing by controlling the strength of inner bonding of the recording paper provided with an ink reception layer to certain limits. However, merely controlling the strength of the inner bonding of the recording paper is insufficient to reduce the occurrence of curl, wrinkles, and undulations. In particular, it is impossible to use the recording paper as a document because curl increases when a large amount of ink is discharged by using an ink with high permeation into the recording paper or when a large amount of ink is discharged per unit of time as a result of a high printing speed, thereby requiring a reduction in the permeation of ink into the recording paper.

Another method has been proposed to reduce curl and wrinkles caused after the recording paper is left out and dried by controlling the irreversible shrinkage in the MD direction and CD direction when the relative humidity is changed, to a fixed range (see Japanese Patent No. 3127114, for example).

However, when the permeation of the ink into the recording paper is not restricted or when the ink is discharged in large amounts because of high permeation of the ink, the ink permeates far into the recording paper. This increases the absolute amount of fiber to be shrunk after the recording paper is dried, and increases curl after the recording paper is left out and dried, and thus, the method fails to provide sufficient effects.

### SUMMARY OF THE INVENTION

The invention provides a recording paper which can be printed on both sides thereof since it suffers reduced curl and cockles immediately after printing; which can have reduced curl or cockles after it is left out and dried in the ink jet recording system; and which can also be used for image formation in the electrophotographic system. The invention further provides a recording method using the recording paper and a method for manufacturing the recording paper.

The present inventors of have studied methods for reducing curls to be generated immediately after the printing on regular paper so as to provide suitability for both-side printing, and for reducing curl and cockles to be generated after the recording paper is left and dried.

As a result, the inventors have confirmed that the curl and cockles caused immediately after printing and after drying result from the rapid extension of the pulp fiber layer which has absorbed water contained in the water-based ink, and also confirmed that the curl and cockles caused after the recording paper is left and dried result from the shrinkage of the ink-absorbed fiber layer due to dehumidification.

From these results, the inventors have studied and tried elastic propagation due to changes in the amount of water in the fiber layer which has absorbed ink, and found that the elastic transferring performance due to water absorption and desorption is caused by changes in the distance between hydrogen bonding inside the recording paper. Consequently, it has been found that the changes in the distance between the hydrogen bonding can be radically restricted by forming bonding not affected by moisture, thereby reducing the curl and cockles caused after printing and the curl and cockles caused after drying.

To be more specific, the first aspect of the invention is a recording paper comprising a substrate, wherein the substrate has a structure in which pulp fibers having reactive groups are cross-linked by a covalent bond via the reactive groups and then made into paper.

The second aspect of the invention is a method for manufacturing the recording paper, wherein the substrate is manufactured by a method comprising: cross-linking pulp fibers having reactive groups by a covalent bond via the reactive groups; and making paper following the cross-linking.

The third aspect of the invention is an ink jet recording method for printing on the recording paper with ink, wherein the ink contains a hydrophilic colorant and water, and the substrate is manufactured by the method of the second aspect of the invention.

Further, the fourth aspect of the invention is anelectrophotographic recording method for forming an image on the recording paper by using an electrophotographic toner, wherein the substrate is manufactured by the method of the second aspect of the invention.

### DETAILED DESCRIPTION OF THE INVENTION

The present invention will be described as follows by being divided into a recording paper and its manufacturing method, an ink jet recording method, and an electrophotographic recording method in that order.

Recording Paper and Manufacturing Method Thereof

The recording paper of the invention comprises at least a pulp fiber-containing substrate, and the substrate is manufactured by at least undergoing a paper-making process at least using pulp fibers. The recording paper is characterized in that the pulp fibers before the application of the paper-making process have reactive groups, and the pulp fibers with the reactive groups before the application of the paper-making process are cross-linked by covalent bonding via the reactive groups, and then made into paper.

Consequently, the recording paper of the invention can be printed on both sides thereof since it suffers reduced curl and cockles immediately after printing; can have reduced curl or cockles after it is left out and dried in the ink jet recording system; and can also be used for image formation in the electrophotographic system.

In the invention, the term “reactive group” indicates a group having reactivity enabling the formation of covalent bonding, and more specifically indicates a group capable of forming covalent bonding which is not easily dissociated under the presence of water molecules by using a chemical reaction or the like.

In the invention, it is preferable that the reactive groups contain a group other than hydroxyl groups (hereinafter abbreviated as non-hydroxyl group) which are contained in large amounts on the pulp fibers, and it is more preferable that the reactive groups are exclusively composed of non-hydroxyl groups.

This is because in the case that the reactive groups are composed exclusively of hydroxyl groups which are present in large amounts on the pulp fibers, a large number of cross-linking bonds are formed via the hydroxyl groups, thereby making the pulp fibers be firmly bonded with each other, which causes the problem of making it difficult to recycle the recording paper manufactured with such pulp fibers.

On the other hand, in general, industrially usable pulp fibers have non-hydroxyl groups thereon although their amount is much smaller than the hydroxy groups. The non-hydroxyl groups often include at least carboxyl groups, which are often contained in the pulp fibers before being subjected to cross-linking in a range of about 5 to 15 meq per 100 g of the pulp fibers. In the prior art case, although it is not intended for the control of the amount of the carboxyl groups, an oxidation treatment such as a chlorous acid treatment is often applied to the pulp fibers, which may form more carboxyl groups on the pulp fibers. In the case that the pulps are manufactured by a sulphite cooking process, the pulp fibers may contain sulfone groups.

Therefore, when recycling performance is taken into consideration, the cross-linking of the pulp fibers is preferably done by making use of the non-hydroxyl groups which are originally contained in smaller amounts than the hydroxyl groups, and whose structure and amount can be controlled by applying a treatment such as an oxidation treatment to the pulp fibers.

In such a case, even if all the non-hydroxyl groups are reacted to form cross-linking bonds as a result of their small amount, the amount of the cross-linking bonds to be formed can be easily controlled by previously controlling the amount of the non-hydroxyl groups which are contributed to the cross-linking bonds, thereby securing the recycling performance.

The cross-linking of the pulp fibers using the non-hydroxyl groups can be started either exclusively from the non-hydroxyl groups or from both the non-hydroxyl groups and hydroxyl groups.

In that case, the cross-linking can be established by directly forming covalent bonding between the non-hydroxyl groups or between the non-hydroxyl group and the hydroxyl group, or a cross-linking agent can be used to cross-link two groups. However, in terms of high flexibility such as the choice of materials for the recording paper, the reactive groups preferably enable the formation of covalent bonding between the reactive groups via a cross-linking agent.

One example of the combination of reactive groups and a cross-linking agent is to use carboxyl groups as the reactive groups and a water-soluble material having at least two amino groups in one molecule as the cross-linking agent (hereinafter also referred to as the amino group-containing water-soluble substance). In that case, the pulp fibers can be cross-linked by amide bonds. The combination of the reactive groups and the cross-linking agent is not limited to the aforementioned example, and a well-known cross-linking agent can be selected according to the type of the selected reactive groups as the starting point of the cross-linking between the pulp fibers.

The following is a detailed description of the structure, materials, and a manufacturing method of the recording paper of the invention.

The substrate contained in the recording paper of the invention is mainly composed of pulp fibers as which well-known pulp fibers can be used. To be more specific, the pulp fibers can be chemical pulps including: hardwood bleached kraft pulps, hardwood unbleached kraft pulps, softwood bleached kraft pulps, softwood unbleached kraft pulps, hardwood bleached sulphite pulps, hardwood unbleached sulphite pulps, softwood bleached sulphite pulps, and softwood unbleached sulphite pulps, all of which are prepared by chemically treating fiber materials such as,wood, cotton, hemp, or bast.

Other usable pulps include ground wood pulps prepared by mechanically pulping wood or chips; chemimechanical pulps prepared by soaking wood or chips in a liquid medicine and then mechanically pulping them; and thermo mechanical pulps prepared by cooking chips until they are softened to some extent and then pulping them by a refiner. These can be used as virgin pulps or mixed with waste paper pulps when necessary.

The pulps used as virgin pulps are preferably subjected to a bleaching treatment by a bleaching method using chlorine dioxide without using chlorine gas (Elementally Chlorine Free; ECF) or a bleaching method (Total Chlorine Free; TCF) mainly using ozone/hydrogen peroxide without using a chlorine compound at all.

Row materials of the waste paper pulps can include: unprinted wastes such as offcuts and brokes of woodfree paper, wood-containing paper and groundwood paper obtained in width cut, bookbinding, printing factories cutting facilities or the like; printed or copied high quality waste paper such as coated/uncoated woodfree paper which have been printed or copied; waste paper with writings with water-based ink, oil-based ink, pencil and the like; and waste paper such as old newspaper including fliers printed on woodfree paper, coated woodfree paper, wood-containing paper, and coated wood-containing paper, wood-containing paper, coated wood-containing paper, and groundwood paper.

When waste paper pulp is used as the row material of the pulp fibers, it is preferable to subject the aforementioned waste paper materials to either an ozone bleaching treatment or a hydrogen peroxide bleaching treatment. In an attempt to obtain paper with a higher degree of brightness, it is preferable that the percentage of the waste paper pulp obtained by the bleaching treatment is not less than 50% by weight and not more than 100% by weight. From the viewpoint of the reuse of resources, it is more preferable that the percentage of the waste paper pulp is not less than 70% by weight and not more than 100% by weight. The ozone treatment has the effect of decomposing fluorescent paint and the like usually contained in high quality paper, and the hydrogen peroxide treatment has the effect of preventing yellowing due to the alkali used in a deinking treatment. It is known that the combination of these two treatments not only facilitates the deinking of waste paper but also improves the degree of brightness of the pulp. The combination has the additional effect of decomposing and removing the chlorine compound remained in the pulp, which has a great effect on a reduction in the amount of the organic halogen compound contained in the waste paper using pulp which has been bleached with chlorine.

Normal pulp fibers contain about 5 to 10 meq/100 g of carboxyl groups. In the preparation of the recording paper of the invention, in order to cross-link the pulp fibers by making use of the carboxyl groups as the reactive groups, such pulp fibers can be used as they are, or can be subjected to an oxidation treatment after being beat so as to introduce more carboxyl groups onto the pulp fibers.

However, an excessive oxidation treatment may decrease the polymerization degree of the pulp fibers, so the amount of carboxyl group contained in the pulp fibers is preferably about 15 meq/100 g or less. There is no particular lower limit to the amount of carboxyl groups contained in the pulp fibers; however, when the number of sites for cross-linking with the carboxyl groups is reduced, the reduction in the occurrence of curls and cockling may become insufficient. Therefore, the lower limit is preferably about 5 meq/100 g or more.

Although the carboxyl groups can be introduced onto the pulp fibers by any oxidation treatment, a chlorous acid treatment is preferable. This is because the chlorous acid treatment enables effective introduction of the carboxyl groups onto the fibers without damaging the polymerization degree of the pulp fibers.

The amount of the carboxyl groups contained in the pulp fibers can be found by being measured in conformity with Tappi Test Methods T237 om-88.

In the case that amide bonding is formed by a cross-linking agent by making use of the carboxyl groups contained in the pulp fibers, an amino group-containing water-soluble substance is used as the cross-linking agent as described above.

Such an amino group-containing water-soluble substance is not specified as long as it contains two or more amino groups in one molecule. Its specific examples include cation polymers such as polyamine amide epihalohydrin, polyacrylamide, and polyallylamine; amino acids such as L-lysine; and food additives such as polylysine.

The amino group-containing water-soluble substance is required to have at least two reaction sites (amino groups) in order to cross-link the pulp fibers. The more reaction sites, the better, and it is preferable that the number of amino groups contained in one molecule is six or greater. It is also preferable that the reaction sites are located at the outermost positions of the molecules. From such a viewpoint, it is more effective to use as the amino group-containing water-soluble substance, dendrimers such as a poly (amido amine) dendrimer and a polylysine dendrimer.

In the case of cross-linking the pulp fibers with the use of carboxyl groups as the reactive groups and amino group-containing water-soluble substance as the cross-linking agent, the pulp fibers and the cross-linking agent (amino group-containing water-soluble substance) can be mixed with each other and stirred for several hours in a water-based solvent to easily form cross-linking portions between the pulp fibers by amide bonding.

As the cross-linking initiator in that case, carbodiimides are often used, although they are not the only material usable. Of carbodiimides, water-soluble ones are preferable such as a 1-ethyl-1,3-(3-dimethylaminopropyl) carbodiimide.

Methods for checking whether the pulp fibers have been cross-linked by amide bonding or not include a direct method for checking the amide bonding of the pulp fibers after the cross-linking treatment with NMR and an indirect method for quantitatively comparing the amounts of the carboxyl groups contained in the pulp fibers before and after the cross-linking treatment.

In the case that NMR is used, to be more specific, ¹³C-NMR can be used to check the pulp fibers which have undergone the cross-linking treatment after the pulp fibers are decomposed into glucose units. The carboxyl groups present in normal pulp fibers and in oxidation-treated pulp fifers are mainly formed as an aldonic acid type in C1 positions at the terminals and are in decyclization. Consequently, if the formation of the cross-linking of the amide bonding is confirmed when measured with ¹³C-NMR, the peak due to the material which has been amide-bonded to two glucose molecules is reflected on the spectrum.

On the other hand, in the case of utilizing the method for quantitatively comparing the carboxyl groups contained in the pulp fibers before and after the cross-linking treatment, the carboxyl groups are quantified based on Tappi-Test-Methods-om237-t88 to confirm that the amount is 1 meq or less per 100 g of the pulp after the cross-linking treatment.

The recording paper of the invention is prepared by subjecting the reactive group-containing pulp fibers at least to a cross-linking process for cross-linking the pulp fibers by covalent bonding via the reactive groups before performing a paper-making process for making the cross-linked pulp fibers into paper. Besides these processes, any other processes used in the well-known methods for manufacturing a recording paper can be used in combination.

In the cross-linking process, it is possible to use a cross-linking agent as mentioned above, and it is also possible to apply a chemical and/or physical treatment before the cross-linking process in order to control the amount of the reactive groups contained in the pulp fibers. For example, for the purpose of controlling the amount of carboxyl groups, an oxidation treatment such as a chlorous acid treatment can be performed.

The recording paper of the present invention is not specifically limited as long as it contains a substrate that has a structure where pulp fibers having reactive groups are cross-linked by a covalent bond via the reactive groups and then made into paper, thus the substrate may further contain various additives and may have a layer formed by coating on either or both side(s) of the substrate if necessary.

For example, the substrate preferably include fillers in order to control unclearness, whiteness and surface property thereof. When a reduction in an amount of halogens contained in the substrate is intended, fillers that do not contain halogens are used. Examples of utilizable fillers include inorganic pigments such as heavy calcium carbonate, light calcium carbonate, chalk, kaolin, calcined clay, talc, calcium sulfate, barium sulfate, titanium dioxide, zinc oxide, zinc sulfide, zinc arbonate, aluminium silicate, calcium silicate, magnesium silicate, synthetic silica, aluminum hydroxide, alumina, sericite, white carbon, saponite, calcium monmorillonite, sodium monmorillonite, and bentonite; and organic pigments such as acrylic plastic pigments, polyethylene, and urea resins. If waste paper pulps are blended to the base paper, the blending amount of the waste paper pulps should be determined by previously estimating the ashes contained in the raw waste-paper pulps.

An internal sizing agent is preferably added to the substrate, and examples of the internal sizing agents include those used in neutral sheeting processes such as neutral rosin-based sizing agents, alkenylsuccinic anhydrides (ASAs), alkylketene dimers (AKDs), and petroleum resin-based sizing agents.

The sizing degree of recording papers can be adjusted only by properly selecting the type and blending ratio of the binders above.

However, if the sizing degree may not be adjusted sufficiently only with the binders above, a solution containing a surface sizing agent may be coated on the substrate and dried so as to obtain the recording paper of the present invention, wherein a layer containing the surface sizing agent is formed at both sides of the substrate.

Examples of the surface sizing agents include rosin-based sizing agents, synthetic sizing agents, petroleum resin-based sizing agents, neutral sizing agents, starch, polyvinylalcohol, and the like. For the purpose of reducing the halogen content of recording papers, it is preferable to use an internal or surface sizing agent that does not contain halogen. Specifically, rosin-based sizing agents, synthetic sizing agents, petroleum resin-based sizing agents, neutral sizing agent, and the like may be used for that purpose. Use of a neutral sizing agent is preferable from the viewpoint of improving the shelf life of recording papers. The sizing degree may be adjusted by controlling the blending amount of sizing agents.

The recording papers according to the invention may be prepared by coating a solution containing a surface sizing agent on a base paper by using a coating means commonly used in the art such as size press, shim size, gate roll, roll coater, bar coater, air knife coater, rod blade coater, and blade coater.

The recording paper of the invention can have the improved effect of reducing occurrences of curl and cockles by decreasing fiber orientation of the pulp fibers. Methods for decreasing fiber orientation include regulating a relativity of JET/WIRE (a speed of jetting row material/a wire speed of the paper machine) and controlling a tension in a machine direction of a recording paper during pressing and the tension in the machine direction during drying with a dryer. Ink jet recording method

Hereinafter, the ink jet recording method according to the invention will be described. The ink jet recording method according to the invention is not particularly limited if an ink is ejected onto the recording paper according to the invention for recording images (printing), and the ink used is also not particularly limited if it is an ink known in the art, and specific examples thereof include an ink containing at least a dye, inks containing at least a hydrophilic colorant and a water-soluble polymer containing both hydrophobic and hydrophilic portions, and the like. Here, the hydrophilic colorant means a dye and/or a pigment, and examples of the pigments include not only hydrophobic pigments dispersed in an ink in combination with a pigment dispersing agent having a hydrophilic group, but also self-dispersing pigments, which will be described below. Solvents for the inks include water and water-soluble organic solvents known in the art, and the inks may additionally contain various additives and the like such as surfactants if necessary.

The inks used for the ink jet recording method according to the invention are preferably the water-soluble inks described above. Examples of ink sets used for multi-color printing may be ink sets including at least black, cyan, magenta, and yellow inks, and the respective inks are prepared by blending water, a water-soluble organic solvent, a colorant, a surfactant, a water-soluble polymer, and the like.

Each ink contains water, a water-soluble organic solvent, a colorant, surfactant, and a water-soluble polymer if necessary, and if a pigment is used as the colorant, the pigment is preferably a self-dispersing pigment (pigment soluble in water without addition of a pigment dispersing agent). The self-dispersing pigment is a pigment containing many hydrophyilic groups on the surface thereof, which can be dispersed consistently in an ink even in the absence of a pigment dispersing agent.

The above “self-dispersing pigment” specifically satisfies the following requirement. A pigment is first dispersed in water at a pigment concentration of 5% by weight with respect to 95% by weight of water without addition of a pigment dispersing agent, by using a dispersing machine such as a ultrasonic homogenizer, nanomizer, microfluidizer, ball mill, or the like. The dispersion, wherein the pigment is dispersed, is then placed in a glass bottle. After allowing the dispersion to stand for a day, the pigment concentration in the supernatant should not be less than 98% of the initial concentration. The method for determining the pigment concentration is not particularly limited and may be a method of determining the amount of solid matters after the sample is dried or of determining the pigment concentration from the light transmittance of a suitably diluted sample. Alternatively, any other method may be used if it can determine the pigment concentration correctly.

The above “self-dispersing pigments” may be produced by subjecting a common pigment to a surface modification treatment, such as an acid-base treatment, coupling agent treatment, polymer-grafting treatment, plasma treatment, oxidation/reduction treatment, or the like. The pigments subjected to such a surface treatment contain more hydrophilic groups than the common pigments, and can be dispersed in ink without use of a pigment dispersing agent.

Common pigments to be subjected to such a surface modification treatment include Raven 7000, Raven 5750, Raven 5250, Raven 5000 ULTRA II, Raven 3500, Raven 2000, Raven 1500, Raven 1250, Raven 1200, Raven 1190 ULTRA II, Raven 1170, Raven 1255, Raven 1080, and Raven 1060 (heretofore, all are trade names, manufactured by Columbian D Carbon); REGAL® 400R, REGAL® 330R, REGAL® 660R, MOGUL® L, BLACK PEARLS® L, MONARCH® 700, MONARCH® 800, MONARCH® 880, MONARCH® 900, MONARCH® 1000, MONARCH® 1100, MONARCH® 1300, and MONARCH® 1400 (heretofore, all are trade names, manufactured by Cabot Corporation); Color Black FW1, Color Black FW2, Color Black FW2V, Color Black 18, Color Black FW200, Color Black S150, Color Black S160, Color Black S170, Printex® 35, Printex® U, Printex® V, Printex® 140U, Printex® 140V, Special Black 6, Special Black 5, Special Black 4A, and Special Black 4 (heretofore, all are trade names, manufactured by Degussa); No.25, No.33, No.40, No.47, No.52, No.900, No.2300, MCF-88, MA600, MA7, MA8, and MA100 (heretofore, all are trade names, manufactured by Mitsubishi Chemical Co., Ltd.); C.I. Pigment Blue-1, C.I. Pigment Blue-2, C.I. Pigment Blue-3, C.I. Pigment Blue-15, C.I. Pigment Blue-15:1, C.I. Pigment Blue-15:3, C.I. Pigment Blue-15:34, C.I. Pigment Blue-16, C.I. Pigment Blue-22, C.I. Pigment Blue-60, C.I. Pigment Red 5, C.I. Pigment Red 7, C.I. Pigment Red 12, C.I. Pigment Red 48, C.I. Pigment Red 48: 1, C.I. Pigment Red 57, C.I. Pigment Red 112, C.I. Pigment Red 122, C.I. Pigment Red 123, C.I. Pigment Red 146, C.I. Pigment Red 168, C.I. Pigment Red 184, C.I. Pigment Red 202, C.I. Pigment Yellow-1, C.I. Pigment Yellow-2, C.I. Pigment Yellow-3, C.I. Pigment Yellow-12, C.I. Pigment Yellow-13, C.I. Pigment Yellow-14, C.I. Pigment Yellow-16, C.I. Pigment Yellow-17, C.I. Pigment Yellow-73, C.I. Pigment Yellow-74, C.I. Pigment Yellow-75, C.I. Pigment Yellow-83, C.I. Pigment Yellow-93, C.I. Pigment Yellow-95, C.I. Pigment Yellow-97, C.I. Pigment Yellow-98, C.I. Pigment Yellow-114, C.I. Pigment Yellow-128, C.I. Pigment Yellow-129, C.I. Pigment Yellow-151, and C.I. Pigment Yellow-154; and the like, but are not limited thereto. Alternatively, magnetic fine particle such as magnetite and ferrite, or titan black may also be used.

In addition, commercially available “self-dispersing pigments” may also be used per se. Examples of these commercially available pigments include CAB-O-JET® 200, CAB-O-JET® 300, IJX-55 (trade name), IJX-164 (trade name), IJX-253 (trade name), IJX-266 (trade name), and IJX-273 (trade name) (heretofore, manufactured by Cabot Corporation); Microjet Black CW-1 (trade name) manufactured by Orient Chemical Industries, Ltd.; pigments sold from Nippon Shokubai Co., Ltd.; and the like.

The hydrophilic group in the “self-dispersing pigment” may be either a nonionic, cationic, or anionic group, but is preferably a sulfate, carboxyl, hydroxyl, phosphate, or other group. If contained, the sulfate, carboxyl, or phosphate group may be used as a free acid or salt. If the acid forms a salt, preferably the counter ion of the acid is generally Li, Na, K, NH₄ or an organic amine.

The content of the pigment in ink with respect to total ink mass is preferably in a range of about 0.1 to 15% by mass, more preferably in a range of about 0.5 to 10% by mass, and still more preferably in a range of about 1.0 to 8.0% by mass. A pigment content of over 15% by mass often leads to clogging at the nozzle tips of print heads, while a pigment content of less than 0.1% by mass may not provide a sufficient image density.

It is preferable to use a purified product as the pigment. The impurities therein may be removed, for example, by rinsing with water, membrane ultrafiltration, ion-exchange treatment, adsorption with activated carbon, zeolite or the like. The purification method is not particularly limited, but the concentration of the inorganic matters derived from impurities of the colorants in ink is preferably 500 ppm or less and more preferably 300 ppm or less.

When a water-soluble colorant, i.e., a dye, is used as the colorant, any one of dyes known in the art or newly prepared may be used. Among them, direct or acid dyes are preferable, as they provide brilliant colors. Specific examples of the dyes include blue dyes such as C.I. Direct blue-1, -2, -6, -8, -22, -34, -70, -71, -76, -78, -86, -142, -199, -200, -201, -202, -203, -207, -218, -236 and -287, and C.I. Acid Blue-1, -7, -9, -15, -22, -23, -27, -29, -40, -43, -55, -59, -62, -78, -80, -81, -90, -102, -104, -111, -185 and -254;

red dyes such as C.I. Direct Red-1, -2, -4, -8, -9, -11, -13, -1, -20, -28, -31, -33, -37, -39, -51, -59, -62, -63, -73, -75, -80, -81, -83, -87, -90, -94, -95, -99, -101, -110 and -189, and C.I. Acid Red -1, -4, -8, -13, -14, -15, -18,-21, -26, -35, -37, -249 and -257; and

yellow dyes such as C.I. Direct Yellow-1, -2, -4, -8, -11, -12, -26, -27, -28, -33, -34, -41, -44, -48, -86, -87, -88, -135, -142 and -144, and C.I. Acid Yellow-1, -3, -7, -11, -12, -13, -14, -19, -23, -25, -34, -38, -41, -42, -44, -53, -55, -61, -71, -76 and -79. These dyes may be used alone or as a mixture of two or more dyes.

In addition to direct or acid dyes, a cationic dye may also be used, and examples thereof include: C.I. Basic Yellow-1, -11, -13, -19, -25, -33, and -36; C.I. Basic Red-1, -2, -9, -12, -13, -38, -39, and -92; C.I. Basic Blue-1, -3, -5, -9, and -19; C.I. -24, -25, -26, and -28.

The total content of these dyes is 0.1% by mass or more and 10% by mass or less, preferably 0.5% by mass or more and 8% by mass or less, and more preferably 0.8% by mass or more and 6% by mass or less with respect to the ink mass. A content of more than 10% by mass leads to clogging at print head tips, while a content of less than 0.1% by mass cannot provide sufficient image quality.

Any known solvents may be used as the water-soluble organic solvent. Examples of the solvents include: polyvalent alcohols such as ethylene glycol, diethylene glycol, propylene glycol, polypropylene glycol, butylene glycol, triethylene glycol, 1,5-pentanediol, 1,2,6-hexanetriol, and glycerin; polyvalent alcohol ethers such as ethylene glycol monomethylether, ethylene glycol monoethylether, ethylene glycol monobutylether, diethylene glycol monomethylether, diethylene glycol monoethylether, diethylene glycol monobutylether, propylene glycol monobutylether, and dipropylene glycol monobutylether; nitrogen-containing solvents such as pyrrolidone, N-methyl-2-pyrrolidone, cyclohexylpyrrolidone, and triethanolamine; monovalent alcohols such as ethanol, isopropylalcohol, butylalcohol, and benzylalcohol: sulfur-containing solvents such as thiodiethanol, thiodiglycerol, sulfolane, and dimethylsulfoxide; propylene carbonate, ethylene carbonate, and the like.

The surfactant described above is added for the purpose of adjusting the surface tension of ink. Nonionic and anionic surfactants are desirable as the surfactant, as they barely affect the dispersion condition of pigments. Examples of the nonionic surfactants include polyoxyethylene nonylphenylether, polyoxyethylene octylphenylether, polyoxyethylene dodecylphenylether, polyoxyethylene alkylethers, polyoxyethylene fatty acid esters, sorbitan fatty acid esters, polyoxyethylene sorbitan fatty acid esters, fatty acid alkylol amides, acetylene alcohol ethyleneoxide adducts, polyethylene glycol polypropylene glycol block copolymers, polyoxyethylene ethers of glycerin esters, polyoxyethylene ethers of sorbitol esters, and the like.

Examples of the anionic surfactants include: alkylbenzenesulfonate salts, alkylphenylsulfonate salts, alkylnaphthalenesulfonate salts, higher fatty acid salts, sulfate and sulfonate salts of higher fatty esters, higher alkyl sulfosuccinate salts, and the like.

Further, examples of the amphoteric surfactants are betaines, sulfobetaines, sulfatobetaines, imidazoline, and the like. In addition to the above surfactants, silicone surfactants such as polysiloxane polyoxyethylene adducts, fluorinated surfactants such as oxyethylene perfluoroalkylethers, biosurfactants such as spiculisporic acid, rhamnolipids, lysolecithins, and the like may also be used.

Method for Preparing Inks

Such inks as described above may be prepared, for example, by adding a predetermined amount of colorants to an aqueous solution; after sufficient stirring, dispersing the mixture by using a dispersing machine; removing the coarse particles therein by means of centrifugation or the like; adding predetermined solvent, additives, and the like; and mixing and subsequently filtering the resulting mixture.

Any commercially available machine may be used as the dispersing machine. Examples thereof include colloid mill, flow jet mill, Thrasher mill, high-speed disperser, ball mill, attriter, sand mill, sand grinder, ultrafine mill, Eiger motor mill, DYNO-Mill, pearl mill, agitator mill, Covol mill, 3-roll mill, 2-roll mill, extruder, kneader, microfluidizer, laboratory homogenizer, ultrasonic homogenizer, and the like, and these machines may be used alone or in combination of two or more. For prevention of contamination by inorganic impurities, it is preferable to adopt a dispersion method that do not require a dispersion medium, and use of a microfluidizer, an ultrasonic homogenizer, or the like is preferable in such a case. Meanwhile, an ultrasonic homogenizer was used for dispersion in the Examples of the invention.

On the other hand, inks containing a self-dispersing pigment as the colorant (pigment) may be prepared by, for example: subjecting the pigment to a surface modification treatment; adding the surfaced-treated pigment into water: after mixing the mixture well, dispersing the mixture if necessary by a dispersing machine similar to that described above; removing the coarse particles therein by means of centrifugation or the like; adding a predetermined solvent, additives and the like; and subsequently stirring, mixing, and filtering the resulting solution.

Properties of Ink

It is preferable that pH of an ink used in the invention is in a range of about 3 to 11, more preferably in a range of about 4.5 to 9.5. Further, when the ink consists of a pigment having an anionic free radical on the surface thereof, pH of the ink is preferably in a range of about 6 to 11, more preferably in a range of about 6 to 9.5, and far more preferably in a range of about 7.5 to 9.0. On the other hand, when the ink consists of a pigment having an cationic free radical on the surface thereof, pH of the ink is preferably in a range of about 4.5 to 8, and more preferably in a range of about 4.5 to 7.0.

The surface tension of the ink may be adjusted mainly by controlling the addition amount of the surfactant above, and is preferably in a range of about 20 to 37 mN/m. A surface tension of less than 20 mN/m leads to excessive ink penetration into the recording paper, sometimes raising the density of the images formed on the back face by penetration and thus decreasing the double-sided printability. A surface tension of greater than 37 mN/m slows down the ink penetration into recording paper, consequently leading to decrease in drying speed and thus in productivity to an extent not suitable for high-speed printing.

The viscosity of the ink is preferably in a range of about 1.5 to 4 Pa.s.

The ink jet recording method according to the invention provides favorable printing quality by any ink jet recording process, if the method is used in the ink jet devices known in the art. The ink jet recording method according to the invention may be applied to the process wherein a heating means for heating recording paper before, during, or after printing is provided and the recording paper and ink are heated at a temperature of 50° C. to 200° C. for acceleration of adsorption and adhesion-fusing of the ink.

Hereinafter, an example of the ink jet recording device suitable for carrying out the ink jet recording method according to the invention will be described. The device is a so-called multi-path system, wherein images are formed by multiple scans of the recording head over the recording paper surface.

A specific example of the process ejecting an ink form the recording head (nozzle) is a so-called thermal ink jet process, wherein the ink in the nozzle is ejected by the pressure caused by foaming of the ink in the nozzle induced by application of electricity to a heater located inside the nozzle. Another example thereof is a process wherein the ink is ejected by the force generated by physical deformation of the nozzles caused by application of electricity to a piezoelectric device. Typically, such a process uses a piezoelectric element for the piezoelectric device. In the ink jet recording device used for the ink jet recording method according to the invention, the method of ejecting ink from nozzle is any of the above two process and is not limited to these process. The same shall apply hereinafter in this respect.

Recording heads (nozzles) are placed in the direction almost orthogonal to the main scanning direction of the head carriage. Specifically, the recording heads are placed in line at a density of 800 pieces per inch. The number and density of the nozzles are arbitrary. In addition, the heads may be placed in a zigzag arrangement, instead of in line.

Ink tanks containing respectively cyan, magenta, yellow and black inks are connected integrally to the upper portion of the respective recording heads. The inks contained in the ink tanks are supplied to the recording heads corresponding to the respective colors. The ink tanks and the heads may not be formed integrally. However, in addition to this process, any other process, wherein for example, the ink tanks and the recording heads may be placed separately and the inks may be supplied to the recording heads via ink-supply tubes, may also be used.

Additionally, a signal cable is connected to each of these recording heads. The signal cables transmit the image information processed in the pixel processing unit concerning respective cyan, magenta, yellow and black colors, to respective recording heads.

The recording heads above are connected to the head carriage. The head carriage is mounted in such a manner that it can slide freely along the guide rod and the carriage guide in the main scanning direction. The head carriage is driven reciprocally via a timing belt along the main scanning direction by activation of a drive motor at predetermined timing.

A platen is connected to the lower portion of the head carriage, and a recording paper is supplied at predetermined timing onto the platen by a conveying roller for paper feed. The platen may be, for example, prepared from a plastic molding material or the like.

In this way, the inks described above may be used for printing images on the recording paper according to the invention. A multi-path system equipped with four pieces of heads is described above as an example. However, the multi-path systems, to which the ink jet recording method according to the invention is applicable, are not limited to this example. A system equipped with two (black and color) heads, wherein the color head is divided into multiple separate compartments for storing predetermined different color inks, from which the inks are supplied to multiple nozzles placed along the color head, may also be used.

In the so-called multi-path system wherein a print head travels in the direction orthogonal to the recording-paper feed direction, printing-head scanning speed is the speed of a moving recording head, when the recording head scans and prints multiple times on the surface of recording paper.

For high-speed printing at a printing speed of 10 ppm (10 sheet/minute) or more, equivalent to that of laser printers available in many offices, the scanning speed of the print head should be not less than 25 cm/sec, which leads to a shorter space between prints printed with two inks which respectively has different colors from each other (namely, ink-ejection pitch) and greater inter color bleeding (ICB). It also demands use of inks having lower surface tension in order to improve drying speed of the inks, and the use of such inks, in turn, causes feathering, deterioration in image density, and, since inks lower in surface tension are more permeable into papers, which may make printed letters and images be seen from back side of the papers and thus may cause inferior double-sided printability.

Hereinafter, a second example of the ink jet recording device for carrying out the ink jet recording method according to the invention will be described. The device is called a one-path system, which has a recording head almost identical in length with the recording paper. In such a system, printing on a recording paper is completed once the paper-conveys under the head. The one-path systems provide a greater scanning speed and thus greater productivity than the multi-path systems, and allow high-speed printing faster than the laser recording process.

The one-path systems are compatible with a recording-paper feed speed (speed of a recording paper passing under the recording head) of 60 mm/sec or more, equivalent to 10 ppm or more, as they do not demand scanning of the recording head multiple times as in multi-path system, easily allowing high-speed printing. However, they also demand ejection of a large amount of ink at the same time, as they cannot print dividedly. Accordingly, conventional ink jet recording methods that do not employ the recording paper according to the invention tend to lead to disorder in conveyance due to deformation of paper and generate rubbings by print head due to cockling, thus caused decrease in document quality.

However, in the ink jet recording method of the invention, even in the case of high-speed printing with a multi-path print head having a scanning speed of about 250 mm/sec. or with a multi-path fixed print head in which the transfer speed of the recording paper is about 60 mm/sec., excellent productivity can be maintained without hindering the recording paper transfer because the amount of deformation of the recording paper is greatly reduced.

The scanning speed of the print head is preferably about 500 mm/sec or more, and more preferably about 1,000 mm/sec or more, from the viewpoint of providing a “productivity equivalent to that of laser printer”. Further, the recording-paper feed speed is preferably about 100 mm/sec or more, and more preferably about 210 mm/sec.

With respect to the ink jet recording method according to the invention, the maximum ink ejection is preferably in a range of about 6 to 30 ml/m².

The maximum ink ejection is an ink quantity ejected in one scan per unit area, when a closely overlapping image is formed by using one or more color ink.

In any one of the process above, the maximum ink ejection should be greater than about 6 ml/m², for ejecting an amount of ink sufficient to form a closely overlapping image in fewer scan number. However, even in high-speed printing which demands such a large ink ejection, use of the ink jet recording method according to the invention provides documented papers without paper deformation such as curl and cockle, allowing both-sides printability comparable to that of laser printing process.

The maximum ink ejection is preferably in a range of about 7 to 20 ml/m², and more preferably in a range of about 10 to 18 ml/m².

As described above, the ink jet recording method according to the invention enables suppression of paper deformation such as curling or cockling, even in an ink jet recording device that prints rapidly at a printing speed of about 10 ppm or more. Further, the ink jet recording method according to the invention enables document production in favorable paper-conveying property and higher productivity. Electrophotographic recording method

Next, the electrophotographic recording method of the invention will be described as follows. The electrophotographic recording method of the invention can be any method as long as images are formed on the recording paper of the invention by using electrophotographic toner (hereinafter sometimes simplified as “toner”). In the case that images are formed on the recording paper of the invention by the electrophotographic recording method, documents having the same quality as in the case of the conventional regular paper can be obtained. Furthermore, the recording paper of the invention can secure the reduction of the occurrence of wrinkles compared with the conventional regular paper because the pulp fibers are cross-linked.

To be more specific, the electrophotographic recording method of the invention preferably comprises: a latent image forming process for forming an electrostatic latent image on the surface of an electrostatic latent image bearing body (electrophotographic photoreceptor); a developing process for forming a toner image by developing the electrostatic latent image formed on the surface of the latent image bearing body with a developing agent; a transferring process for transferring the toner image formed on the surface of the latent image bearing body onto the surface of a body to be transferred; and a fusing process for fusing the toner image transferred on the surface of the body to be transferred. And other well-known processes can be added when necessary.

The image forming device used in the electrophotographic recording method of the invention can be anything as long as it utilizes the electrophotographic system. For example, when four color toners of cyan, magenta, yellow, and black are used, it is possible to use a color image forming device of four-cycle developing type which forms a toner image by sequentially providing one photoreceptor with developing agents containing the respective color toners, or to use a color image forming device (so-called tandem machine) equipped with four developing units which correspond to the respective colors and which can perform at least the latent image forming process and the developing process.

The toner used for the image formation is not particularly limited as long as it is well known. For example, it is possible to use a toner with a spherical shape and a small particle size distribution so as to obtain high precision images, or to use a toner containing a binder resin which can be fused at low temperatures due to its low melting point so as to achieve energy saving.

### EXAMPLES

The present invention will be specifically described in the following examples; however, it goes without saying that the invention is not limited to these examples. The recording paper and ink used in the examples and the comparative examples will be described first, and then the results of various evaluations of printing in the combinations of these will be described.

Recording Paper 1

Hardwood kraft pulp which has been beat to have 530 ml of freeness is adjusted to have a 10% pulp concentration.

Next, 2.85 l of ion exchange water is added to and dissolved in 90.44 g of sodium chlorite (NaClO₂); 1 l of 5 N acetic acid is added; and more ion exchange water is added so as to prepare a 4.1 l aqueous solution. Then, 1 kg of the previously prepared pulp is added to the solution, subjected to an oxidation treatment for 24 hours at 20° C., and then cleaned with cold water so as to obtain pulp that contains 6.7 meq/100 g of carboxyl group.

After this pulp is again water distributed and 30 parts by weight of polyamidoamine (trade name: PAMAM Dendrimer Generation 4, manufactured by Aldrich) is added to the pulp, the pH of the slurry is adjusted to 4.75 by using 0.1 N hydrochloric acid.

Then, 15 parts by weight of water-soluble 1-ethyl -1,3-(3-dimethylaminopropyl) carbodiimide hydrochloride is added to the pulp and stirred for four hours. Later, the pulp is cleaned with cold water to remove amide derivative which is a by-product. Then, by preparing pulp slurry having a pulp concentration of 0.3% by weight and adding 0.1 parts by weight of alkenyl succinic anhydride (trade name: Fibran-81, manufactured by National Starch & Chemical) and 0.5 parts by weight of cationic corn starch (trade name: Cato-304, manufactured by Nippon NSC, Ltd.) as internal sizing agents, paper making is performed under the conditions of a paper-making speed of 1000 m/min. and a paper material discharging pressure of 1.5 kg/cm² by using a 80-mesh wire and an oriented paper machine for laboratory use manufactured by Kumagai Riki Kogyo Co., Ltd.

Later, the recording paper obtained by the paper making is pressed with a press for a square paper machine manufactured by Kumagai Riki Kogyo Co., Ltd. for 3 minutes at 10 kg/cm², and dried under the conditions of 110° C. and 0.5 m/min. by using a rotary dryer (trade name: KRK, manufactured by Kumagai Riki Kogyo Co., Ltd.), thereby obtaining 70 g/m² of recording paper.

Part of the pulp fibers of the recording paper thus prepared is taken and subjected to acid hydrolysis with trifluoroacetic acid so as to confirm the generation of the peak of digluconamide using ¹³C-NMR.

On the other hand, no peak resulting from digluconamide has been confirmed from the hardwood kraft pulp used for the preparation of the recording paper.

Recording Paper 2

The same oxidation treatment as in recording paper 1 is carried out except that the softwood sulphite pulp which has been beat to have 530 ml of freeness is used, thereby obtaining pulp containing 7.8 meq/100 g of carboxyl group. After this, the same processes as in recording paper 1 are continued to obtain a substrate.

Later, both sides of the substrate are coated with a coating solution composed of 5 parts by weight of oxidized corn starch (trade name: ACE-A, manufactured by Oji Cornstarch Co., Ltd.), 5 parts by weight of calcium acetate, and 90 parts by weight of water by using a wire bar. As a result, 72 g/m² of recording paper is obtained.

The pulp fibers of the recording paper thus prepared are analyzed by ¹³C-NMR in the same manner as in the case of recording paper 1 so as to confirm the peak of digluconamide.

On the other hand, no peak resulting from digluconamide has been confirmed from the softwood sulphite pulp used for the preparation of the recording paper.

Recording Paper 3

The same oxidation treatment as in the case of recording paper 1 is carried out except that the beating is performed using medium quality waste paper pulp, thereby obtaining pulp containing 8.5 meq/100 g of carboxyl group. After this, the same treatment as in the case of the recording paper 1 is carried out to obtain pulp containing 70 g/m² of recording paper.

The pulp fibers of the recording paper thus prepared are analyzed by ¹³C-NMR in the same manner as in the case of recording paper 1 so as to confirm the peak of digluconamide.

On the other hand, no peak resulting from digluconamide has been confirmed from the medium quality waste paper pulp used for the preparation of the recording paper.

Recording Paper 4

The same treatment as in the case of the recording paper 1 is carried out except that a polyamine amide epihalohydrin resin (trade name: DA108, manufactured by Seiko PMC Corporation) is used in place of PAMAM Dendrimer, thereby obtaining pulp containing 70 g/m² of recording paper.

The pulp fibers of the recording paper thus prepared are analyzed by ¹³C-NMR in the same manner as in the case of recording paper 1 so as to confirm the peak of digluconamide.

Recording Paper 5

The same treatment as in the case of recording paper 1 is carried out except that PAMAM Dendrimer nor water-soluble 1-ethyl-1,3-(3-dimethylaminopropyl) carbodiimide hydrochloride is added to the pulp, thereby obtaining 70 g/m² of recording paper.

As a result that the pulp fibers of the recording paper thus prepared are analyzed by ¹³C-NMR in the same manner as in the case of recording paper 1, no generation of the peak of new amide bonding such as digluconamide has been confirmed as compared with the original pulp material used for the preparation of the recording paper.

Recording Paper 6

Color PPC paper (trade name: CLC-paper, manufactured by Canon Sales Co., Inc.) is used as recording paper 6. The weight is 81.6 g/m².

Recording Paper 7

During the cooking, anthraquinone is added to perform kraft cooking, and hardwood kraft pulp which has been bleached by an ozone treatment is beat to have 530 ml of freeness, and then adjusted to have a 10% pulp concentration.

Next, 2.85 l of ion exchange water is added to and dissolved in 90.44 g of sodium chlorite (NaClO₂); 1 l of 5 N acetic acid is added; and more ion exchange water is added so as to prepare a 4.1 l aqueous solution. Then, 1 kg of the previously prepared pulp is added to the solution, subjected to an oxidation treatment for 72 hours at 20° C., and then cleaned with cold water so as to obtain pulp containing 14.7 meq/100 g of carboxyl group. After this, the same processes as in the case of recording paper 1 are continued to obtain a substrate.

Later, both sides of the substrate are coated with a coating solution composed of 5 parts by weight of oxidized corn starch (trade name: ACE-K, manufactured by Oji Cornstarch Co., Ltd.), 5 parts by weight of calcium acetate, and 90 parts by weight of water by using a wire bar. As a result, 72 g/m² of recording paper is obtained.

The pulp fibers of the recording paper thus prepared are analyzed by ¹³C-NMR in the same manner as in the case of recording paper 1 so as to confirm the peak of digluconamide.

On the other hand, no peak resulting from digluconamide has been confirmed from the hardwood kraft pulp used for the preparation of the recording paper.

Ink 1

In this ink, a water-soluble polymer, sodium salt of a styrene/methacrylic acid copolymer (monomer ratio: 50/50, weight-average molecular weight: 7,000), is used as the dispersant for dispersing pigments therein.

To a stirred mixture of 45 parts by weight of an aqueous solution of the water-soluble polymer (solid matter: 10% by weight) and 210 parts by weight of ion-exchange water, 45 parts by weight of carbon black (trade name: BPL, manufactured by CABOT) is added, and the resulting mixture is stirred for 30 minutes. Then, the mixture is dispersed by a microfluidizer under a condition at 10,000 psi and 30 paths. After dispersion, the dispersion is adjusted with 1N aqueous NaOH solution to pH 9, and further centrifuged (at 8,000 rpm for 15 minutes) by a centrifugal separator, and filtered through a 2-μm membrane filter. The dispersion thus obtained is diluted with demineralized water, to provide a pigment dispersion having solid matters at 10% by weight.

Ethylene glycol: 12 parts by weight

Ethanol: 4 parts by weight

Urea: 5 parts by weight

Sodium laurylsulfate: 0.1 part by weight

Subsequently, deionized water is added to the mixture having the composition above to a total amount of 50 parts by weight, and the mixture is stirred for 30 minutes. Then, 50 parts by weight of the pigment dispersion above is added to the mixture, and the resulting mixture is stirred for additional 30 minutes. The resulting mixture is filtered through a 2-μm membrane filter, to provide an ink 1. The surface tension of this ink is 35 mN/m, and the viscosity thereof 2.6 mPa.s. The storage elasticity thereof is 1.0×10⁻³ Pa at 24° C., and the number of coarse particles in ink 1 having a particle diameter of 500 nm or more, 11.2×10⁴.

Ink 2

Pigment (C. I. Pigment Blue 15:3): 4 parts by weight

Diglycerinethyleneoxide additive: 5 parts by weight

Sulfolane: 5 parts by weight

Surfactant (trade name: Nonion E-215, manufactured by Nippon Oil & Fat Corporation): 0.03 parts by weight

Deionized water is added to the mixture having the composition above to a total amount of 50 parts by weight, the mixture resulting liquid is stirred for 30 minutes, and then filtered through a 2-μm membrane filter, to provide an ink 2. The surface tension of the ink is 30 mN/m, and the viscosity 2.8 mPa.s. The storage elasticity thereof is 2.5×10⁻³ Pa at 24° C., and the number of coarse particles in ink 2 having a particle diameter of 500 nm or more 0.08×10⁴.

Ink 3

Pigment (C. I. Pigment Red 122): 4 parts by weight

Diethyleneglycol: 10 parts by weight

Propyleneglycol: 5 parts by weight

Thiodiethanol: 5 parts by weight

Surfactant (trade name: Surfynol 465, manufactured by Nissin Chemical Industry Co., Ltd.) 0.03 parts by weight

Deionized water is added to the mixture having the composition above to a total amount of 100 parts by weight, the mixture resulting liquid is stirred for 30 minutes, and then filtered through a 2-μm membrane filter, to provide an ink 3. The surface tension of the ink is 28 mN/m, and the viscosity 2.8 mPa.s. The storage elasticity thereof is 1.0×10⁻³ Pa at 24° C., and the number of coarse particles in ink 3 having a particle diameter of 500 nm or more 0.03×10⁴.

Ink 4

Dye (Direct Red 227, 10% aqueous solution): 20 parts by weight

Ethylene glycol: 25 parts by weight

Urea: 5 parts by weight

Surfactant (trade name: Surfynol 465, manufactured by Nissin Chemical Industry Co., Ltd.): 2 parts by weight

Deionized water is added to the mixture having the above composition to a total amount of 100 parts by weight, and the mixture is stirred for 30 minutes, and then filtered through a 1-μm membrane filter, to provide an ink 4. The surface tension of this ink is 31 mN/m, and the viscosity 2.0 mPa.s. The storage elasticity thereof is 1.0×10⁻² Pa at 24° C.

Evaluation

Printing tests of the recording papers and inks thus obtained are performed in an ink jet recording device, using the combinations thereof shown in Table 1, and the recording papers and the inks are evaluated. “No.” in the column of “paper” shown in Table 1 corresponds to the number of the recording paper in each Example or Comparative Example (e.g., recording paper 2 in Example 1). “No.” in the column of “ink” corresponds to the number of the inks used in each Example or Comparative Example.

TABLE 1

| | | Ink | | | | |
|---|---|---|---|---|---|---|
| | | | | | Surface | |
| | Paper | | | Coloring | tension | Water-soluble |
| | No. | No. | Color | material type | (mN/m) | polymer |
| Example 1 | 1 | 1 | Black | Pigment | 35 | Styrene/methacrylic |
| | | | | | | acid copolymer |
| Example 2 | 2 | 2 | Cyan | Pigment | 30 | None |
| Example 3 | 3 | 3 | Magenta | Pigment | 28 | None |
| Example 4 | 4 | 4 | Magenta | Dye | 31 | None |
| Example 5 | 7 | 1 | Black | Pigment | 35 | Styrene/methacrylic |
| | | | | | | acid copolymer |
| Comparative | 5 | 1 | Black | Pigment | 35 | Styrene/methacrylic |
| example 1 | | | | | | acid copolymer |
| Comparative | 5 | 3 | Magenta | Pigment | 28 | None |
| example 2 | | | | | | |
| Comparative | 6 | 4 | Magenta | Dye | 31 | None |
| example 3 | | | | | | |

Evaluation of Physical Properties of Inks

The surface tension is determined under an environment of 23° C. and 55% RH using a Wilhelmy surface tension balance. A sample ink is placed in a measuring container by using a viscometer (trade name: Rheomat 115, manufactured by Contraves) according to a predetermined procedure, which is then mounted on the balance, and the surface tension is determined by the balance. The measurement temperature is 23° C., and the shear rate is 1,400 s⁻¹.

Printing Condition

The thermal ink jet recording device used for printing test is the WorkCentre B900 (trade name, manufactured by Fuji Xerox Co., Ltd.). The printing tests are conducted under an environment of 23° C. and 55% RH. The printing device has a nozzle pitch of 800 dpi, 256 nozzles, a drop volume of about 15 pl, the maximum ink ejection of about 15 ml/m². The printing mode is single-sided batch printing, and the head scan speed is about 1100 mm/sec. The results obtained by conducting each evaluations under above-describe conditions are shown in Table 2.

Image Forming Conditions

Besides the printing tests with the aforementioned ink jet recording device, image forming tests are conducted with an electrophotographic type image forming device (trade name: Docu Print C2220, manufactured by Fuji Xerox Co., Ltd.). The image forming tests are conducted in the same conditions in all examples and comparative examples, and the results of the evaluations are shown in Table 2.

TABLE 2

| | Ink jet recording | | | | Electrophotographic recording | | |
|---|---|---|---|---|---|---|---|
| | Ink | Curls | Cackles | Curls | Evaluation | Evaluation | |
| | drying | immediately | immediately | after | of wrinkles | of wrinkles | Print |
| | time | after printing | after printing | drying | (1) | (2) | defect |
| Example 1 | C | A | A | A | B | B | None |
| Example 2 | A | A | A | A | A | B | None |
| Example 3 | A | A | A | A | A | A | None |
| Example 4 | A | A | A | A | A | A | None |
| Example 5 | B | A | A | A | A | A | None |
| Comparative | C | D | C | C | D | D | Present |
| Example 1 | | | | | | | |
| Comparative | B | D | C | D | D | D | Present |
| Example 2 | | | | | | | |
| Comparative | B | D | D | D | D | B | Present |
| Example 3 | | | | | | | |

The evaluations shown in Table 2 were conducted in following manners.

1) Evaluation in Ink Jet System

Evaluation of the Curl Immediately After Printing

A closely overlapping 100%-monochromous image is printed on a postcard-sized recording paper having 5-mm margins. The amount of the hanging curl generated on the opposite face of printed face immediately after printing is determined. The measured values are converted to and evaluated by curvatures. The evaluation criteria are as follows, and A and B indicate that the corresponding inks are on the allowable level.

A: Less than 20 m⁻¹.

B: 20 m⁻¹ or more and less than 35 m⁻¹.

C: 35 m⁻¹ or more and less than 50 m⁻¹.

D: 50 m⁻¹ or more.

Evaluation of Cockle Immediately After Printing

A 2 cm×2 cm closely overlapping 100%-monochromous image is printed at the center of a postcard-sized recording paper, and the maximum altitude of the resulting wave generated immediately after printing is determined by a laser displacement meter. The evaluation criteria are as follows, and A and B indicate that the corresponding inks are on the allowable level.

A: Less than 1 mm.

B: 1 mm or more, and less than 2 mm.

C: 2 mm or more, and less than 3 mm.

D: 3 mm or more.

Evaluation of the Curl After Drying

A closely overlapping 100%-monochromous image is printed on a postcard-sized recording paper having 5-mm margins, and the paper is allowed to stand flat with the printed face facing upward under an environment of 23° C. and 50% RH for 100 hours after printing, and the amount of the hanging curl generated is determined. The measured values are converted to and evaluated by curl curvatures. The evaluation criteria are as follows, and A and B indicate that the corresponding inks are on the allowable level.

A: Less than 20 m⁻¹.

B: 20 m⁻¹ or more, and less than 35 m⁻¹ .

C: 35 m⁻¹ or more, and less than 50 m⁻¹ .

D: 50 m⁻¹ or more.

2) Evaluation on the Electrophotographic Type

Evaluation of Wrinkles (1)

After leaving recording papers of post card size for 2 hours in the environment of 28° C. and 85% RH, the heights of wrinkles at the ends of the recording papers are measured with a laser displacement gauge. The evaluation standards are as follows, in which A and B indicate permissible ranges.

A: Less than 2 mm.

B: Not less than 2 mm and below 5 mm.

C: Not less than 5 mm and below 10 mm.

Evaluation of Wrinkles (2)

At the same time as the measurements in the evaluation of wrinkles (1), the numbers of crests of wrinkles at the ends of the recording papers (longitudinal direction) are counted. The evaluation standards are as follows, in which A and B indicate permissible ranges.

A: Less than 3.

B: 3 to 4.

C: 5 or more.

Print defects

With DocuCentreColor 2220 (mentioned above), gray images having a 50% concentration are printed on the entire surface of the recording papers used in the evaluation of wrinkles (1) so as to confirm dropouts of images due to wrinkles. The recording papers with image dropouts are determined to be unsuitable for practical use.

As described hereinbefore, the invention provides a recording paper which can be printed on both sides thereof since it suffers reduced curl and cockles immediately after printing; which causes reduced curl or cockles after it is left out and dried in the case of the ink jet recording system; and which can also be used for image formation in the electrophotographic recording system. The invention further provides a recording method using the recording paper, and a method for manufacturing the recording paper.

What is claimed is:

1. A recording paper comprising a substrate, wherein the substrate has a structure in which pulp fibers having reactive groups are cross-linked by a covalent bond via the reactive groups and then made into paper.

2. A recording paper according to claim 1, wherein the reactive groups include a carboxyl group.

3. A recording paper according to claim 2, wherein the carboxyl group is contained in the pulp fibers before being subjected to cross-linking in a range of about 5 to 15 meq per 100 g of the pulp fibers.

4. A recording paper according to claim 1, wherein the pulp fibers are cross-linked at least by amide bonds.

5. A recording paper according to claim 1, wherein a layer containing a surface sizing agent is formed at both sides of the substrate.

6. A method for manufacturing a recording paper comprising a substrate, wherein the substrate is manufactured by a method comprising:
cross-linking pulp fibers having reactive groups by a covalent bond via the reactive groups; and
making paper following the cross-linking.

7. A method according to claim 6, wherein a cross-linking agent is used in the cross-linking.

8. A method according to claim 6, wherein the reactive groups include a carboxyl group.

9. A method according to claim 8, wherein an amount of the carboxyl group contained in the pulp fibers before the cross-linking is in a range of about 5 to 15 meq per 100 g of the pulp fibers.

10. A method according to claim 7, wherein the cross-linking agent is an amino group-containing water-soluble substance having at least two amino groups in one molecule.

11. A method according to claim 10, wherein the amino group-containing water-soluble substance has at least six amino groups in one molecule.

12. A method according to claim 6, further comprising applying an oxidation treatment to the pulp fibers prior to the cross-linking to thereby form the reactive groups on the pulp fibers.

13. A method according to claim 12, wherein the oxidation treatment is a chlorous acid treatment.

14. A method according to claim 6, further comprising coating a solution containing a surface sizing agent onto both sides of the substrate.

15. An ink jet recording method for printing on a recording paper with ink, wherein
the ink contains a hydrophilic colorant and water,
the recording paper contains a substrate, and
the substrate is manufactured by a method comprising:
cross-linking pulp fibers having reactive groups by a covalent bond via the reactive groups; and
making paper following the cross-linking.

16. A method according to claim 15, wherein a surface tension of the ink is in a range of about 20 to 37 mN/m.

17. A method according to claim 15, wherein a viscosity of the ink is in a range of about 1.5 to 4 Pa.s.

18. An electrophotographic recording method for forming an image on a recording paper by using an electrophotographic toner, wherein
the recording paper contains a substrate, and
the substrate is manufactured by a method comprising:
cross-linking pulp fibers having reactive groups by a covalent bond via the reactive groups; and
making paper following the cross-linking.
